(19) United States
(12) Patent Application Publication
(10) Pub. No.: US 2016/0054149 A1
(43) Pub. Date: Feb. 25, 2016

(54) SYSTEM AND METHOD FOR TRACKING LINEAR POSITION AND ROTATION OF A PISTON

(71) Applicant: Zedi Canada Inc., Edmonton (CA)

(72) Inventor: Gabriel Jarillo Alvarado, Edmonton (CA)

(73) Assignee: Zedi Canada Inc., Edmonton (CA)

(21) Appl. No.: 14/830,493

(22) Filed: Aug. 19, 2015

Related U.S. Application Data
(60) Provisional application No. 62/039,501, filed on Aug. 20, 2014.

(51) Int. Cl. G01D 5/14; G01D 5/20

(52) U.S. Cl. CPC G01D 5/145; G01D 5/2013

(57) ABSTRACT

A system and method to determine linear and approximate rotational position of a reciprocating and rotating hydraulic cylinder. The system uses two magnetic rings offset a distance, each ring having a continuous arc of magnetic material terminating in a blind zone, where the blind zone produces a magnetic field substantially different from the continuous arc region. The magnetic fields are used to detect location and rotation by an magnetic sensor that interacts with the magnets and blind zone.

### CROSS-REFERENCE TO RELATED APPLICATIONS

This application claims the benefit of and priority to U.S. Provisional Patent Application No. 62/039,501, filed on Aug. 20, 2014, which application is incorporated by reference herein.

### BACKGROUND OF THE INVENTION

This invention relates to a system and method for tracking linear position and rotation of a piston.

### SUMMARY OF THE INVENTION

A linear actuator is provided that includes a cylinder and a piston disposed inside the cylinder for reciprocal movement along a cylinder axis and rotational movement about the axis. The cylinder has a wall with an internal surface and an external surface. The piston has axially spaced first and second end surfaces. The actuator includes a magnetic sensor axially disposed adjacent to the external surface of cylinder. The actuator includes a rod connected to the piston. The actuator includes a first ring operationally coupled to the piston or rod at a first location. The first ring comprises a magnetic field generating material disposed in a substantially continuous first ring arc region. The first ring arc region is located on an outer perimeter of the first ring. The magnetic field generating material in the first ring arc region has a first magnetic polarity orientation. The first ring arc region terminates in a first ring blind zone in the first ring. The actuator includes a second ring operationally coupled to the piston or rod at a second location. The first location axially spaced apart from the second location by a distance D. The magnetic field generating material is disposed in a substantially continuous second ring arc region located on an outer perimeter of the second ring. The magnetic field generating material in the second ring arc region has the first magnetic polarity orientation. The second ring arc region terminates in a second ring blind zone. The first ring blind zone is axially aligned with the second ring arc region. The second ring blind zone is axially aligned with the first ring arc region. The magnetic field produced by the first ring blind zone and the second ring blind zone are substantially different from the magnetic field produced in the first ring arc region or the second ring arc region respectively.

In an embodiment of the linear actuator, the blind zones produce magnetic field lines reversed from the magnetic field lines in the respective magnetic arc regions.

In an embodiment of the linear actuator, the first and second rings each have a single blind zone. The blind zone of the first ring is separated from the blind zone of the second ring by 25-180 degrees.

In an embodiment of linear actuator, the first and second rings each have two or more blind zones.

In an embodiment of the linear actuator, the magnetic sensor comprises a Hall effect bar sensor.

In an embodiment of the linear actuator, the magnetic sensor is configured to output a value that is related to the location of the piston in the cylinder.

In an embodiment of the linear actuator, the output value is further related to either the position of the first ring or the position of the second ring.

In an embodiment of the linear actuator, the linear actuator further includes a controller. The controller is in communication with the magnetic sensor. The controller is configured to determine which of the first or second rings position is related to the magnetic sensor output.

In an embodiment of the linear actuator, the controller is further configured to output a piston position in the cylinder. The controller determined piston position is equal to (a) the magnetic sensor determined piston position or (b) the magnetic sensor determined piston position, plus or minus D.

A method to determine linear position and rotation of a reciprocating and rotating piston in a hydraulic cylinder is also provided. The method uses the output of a magnetic sensor wherein an absolute value of a change in piston location, between sequential measurements of the piston by the magnetic sensor, is a value A. The method includes the steps of receiving a first output of the magnetic sensor. The first output is correlatable to a first linear position of the piston in the hydraulic cylinder. The method includes the step of receiving a sequential second output of the magnet sensor. The second output is correlatable to a second linear position of the piston in the hydraulic cylinder. The method includes the step of determining that the cylinder is rotating when the absolute value of difference of the second linear position and the first linear position exceeds A by a predetermined value P.

In another alterative embodiment a method is provided to determine linear and approximate rotational position of a reciprocating and rotating piston in a hydraulic cylinder. The stroke speed of the piston is less than Y in absolute value. The method includes the steps of receiving a plurality of outputs of the magnetic sensor and determining a linear position of the piston for each of the outputs. The method includes the step of determining a derivative of a quantity related to the output of the magnetic sensors. The method includes the step of determining that the piston has rotated when the absolute value of the derivative exceeds a predetermined value.

In an embodiment of the alternative method, the derivative is taken of the outputs of the magnet sensor.

In an embodiment of the alternative method, the derivative is taken from a position calculated based on the outputs of the magnet senor.

In an embodiment of the alternative method, the predetermined value in absolute value is greater than Y.

Another alternative method of determining piston location in a system is provided. The method includes a linear actuator comprising a piston and a cylinder. The piston is disposed inside the cylinder for reciprocal movement along a cylinder axis and rotational movement about the axis. The cylinder has a wall with an internal surface and an external surface. A magnetic sensor is axially disposed along the external surface of the cylinder. A rod is connected to the piston. A first ring is operationally coupled to the piston or the rod at a first location. The first ring comprises a magnetic field generating material disposed in a substantially continuous first ring arc region. The first ring arc region is located on an outer perimeter of the first ring. The magnetic field generating material in the first ring arc region has a first magnetic polarity orientation. The first ring arc region terminates in a first ring blind zone. A second ring is operationally coupled to the piston or rod at a second location. The first location is axially spaced apart from the second location by a distance D. A magnetic field generating material is disposed in a substantially continuous second ring arc region located on an outer perimeter of the second ring. The magnetic field generating material in the second ring arc region has the first magnetic polarity orientation. The second ring arc region of magnetic field generating material terminates in second ring blind zone. The first ring blind zone is axially aligned with the second ring arc region. The second ring blind zone is axially aligned with the first ring arc region. The first ring and the second rings move with the piston but are fixed with respect to one another. The method includes the steps of determining a position of the piston by interaction of the first magnetic arc region with the magnetic sensor. The method includes the step of on interaction of the first ring blind zone with the magnetic sensor, determining the position of the piston through interaction of the second ring arc region with the magnetic sensor. The method includes the step of on interaction of the second ring blind zone with the magnetic sensor, determining the position of the piston based upon interaction of the first ring arc region with the magnetic sensor. The method includes the step of repeating the first two steps.

In an embodiment of this alternative method, the method further includes the steps of determining that the piston has rotated 360 degrees after performing each occurrence of the prior two steps.

In an embodiment of this alternative method, the magnetic field generating material are permanent magnets.

In an embodiment of this alternative method, the blind zones further comprise blind zone permanent magnets orientated opposite that of the permanent magnets of the arc regions.

### BRIEF DESCRIPTION OF THE DRAWINGS

FIG. 1A is side view of one embodiment of a cylinder.

FIG. 1B is a cross-sectional cutaway view of a cylinder showing the piston and rod.

FIG. 2 is a perspective view of one embodiment of the dual rings.

FIG. 3 is a plot of piston position.

FIG. 4 is a plot of piston position of FIG. 3 with the derivative superimposed.

FIG. 5 is a schematic detailing two rings with four blind zones.

### DETAILED DESCRIPTION OF THE INVENTION

In many applications using a reciprocating piston (such as a pump), it is desired to track the linear position of the piston within the piston cylinder. One such application is in oil and gas well lift technology, such as jack pumps. In certain applications, it is also desirable to have the piston rotate within the cylinder. For instance, in hydraulic rod pump technology, it is desirable to have the rod rotate over time to even the wear surfaces of the mechanical parts that are in motion during the oil or gas extraction process. The following description is for a system to track both linear and rotational motion in an hydraulic rod pump. But, the system is also suitable for use in any system where the piston actuator both rotates and translates in the cylinder, and the position of the piston (or the connected rod) is tracked using magnet field interaction technologies, such as Hall effect technology, magnetostrictive technologies, magnetic reed switches, and the like.

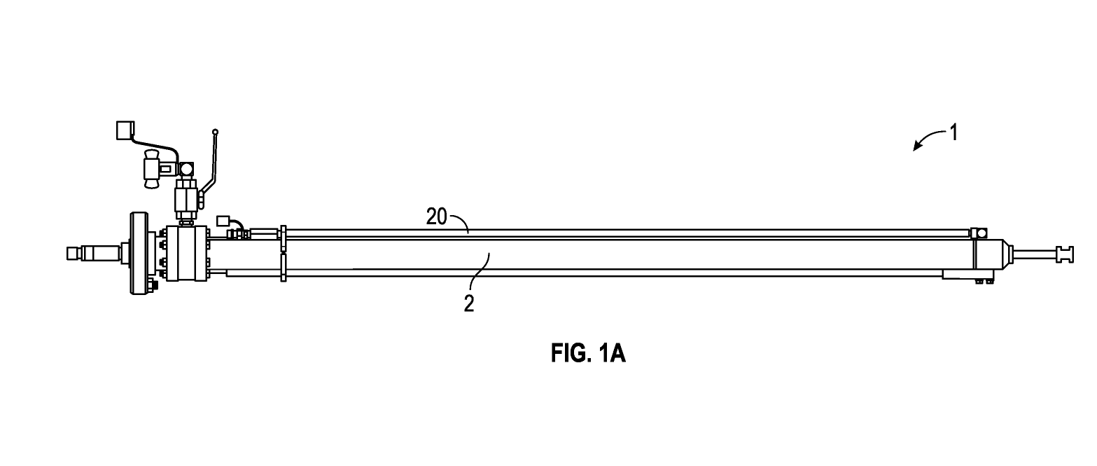

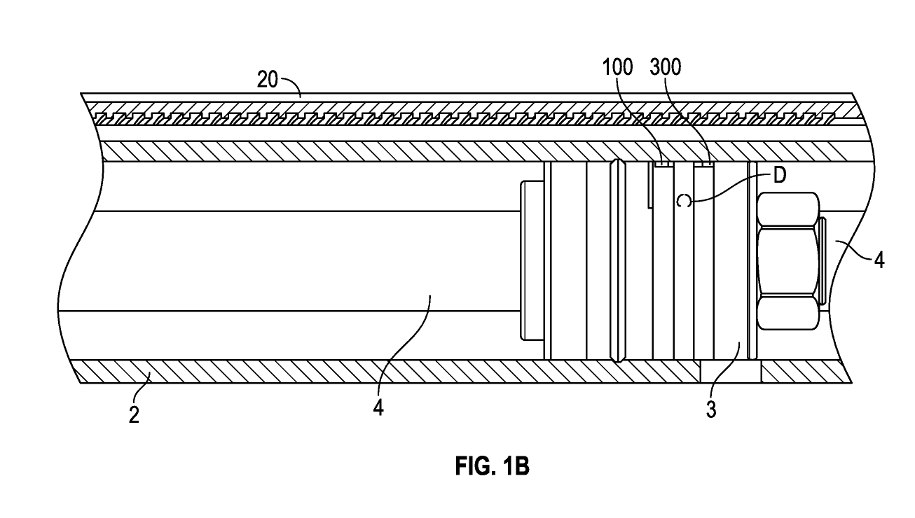

In an hydraulic rod pump system, the system includes a hydraulic cylinder 1 as seen in FIG. 1A, a hydraulic power unit, and an electronic control system. The hydraulic power unit provides the power source to move the piston in hydraulic cylinder 1, with the control system operating the associated valves to control fluid flow between upstrokes and downstrokes at the appropriate time. Hydraulic cylinder 1 is a main working part of the system and is usually installed on the well head pumping tee by pipe swage and hammer union. The well is closed hermetically and there are no visible moving parts.

As seen in FIG. 1B, hydraulic cylinder 1 includes an outer cylindrical chamber wall 2, a piston 3 that is slidably positioned within cylinder 1 and sealed to the inside surface of cylinder 1 so as to divide cylinder 1 into two chambers. Rod 4 is connected to piston 3 (a cylinder rod or piston rod). Piston 3 is slidable under the influence of hydraulic or pneumatic fluid. In some pumps, the pumping action can be accomplished by mechanical or hydraulic reciprocation of the rod. In action, piston 3 and rod 4 move under fluid pressure (e.g., hydraulic pressure supplied from the hydraulic power unit) from an extended position, in which piston 3 is fully advanced within chamber 2 and closest to the well head, to a retracted position, in which piston 3 is furthest from the well head. The distance between the extended and retracted position reflects the “stroke” length of hydraulic cylinder 1. The linear speed of piston 3 along the cylinder axis (the “stroke speed”) can be fairly constant. The ability or lifting capacity of hydraulic cylinder 1 depends on stroke length, the diameter of the internal cylinder bore, (and hence, the piston diameter), and the stroke speed of piston 3. To maintain accurate pumping characteristics of cylinder 1, it is often desirable to operate the control valves/control system in response to a signal representing the position of piston 3 or piston rod 4, relative to cylinder 1. In this instance, it is necessary to have the ability to sense the position of piston 3 or piston rod 4 in an accurate manner. It is also desirable to measure or count piston 3 rotation over time to verify even component wear.

To track the position of piston 3, an embodiment of the system employs a magnetically interactive sensor 20 mounted adjacent to the exterior of cylinder 1. Magnets are mounted to piston 3 or rod 4 internally within cylinder 1. These internal magnets interact with the externally mounted magnetic sensor 20, and a “position” of piston 3 can be derived based on the magnetic sensor output. One such externally mounted magnetic sensor is a sensing strip or bar 20 that extends on the outer surface of cylinder 1 between the extended and retracted positions of piston 3, such as shown in FIG. 1A. An example of a suitable strip is known as the “Rota” device and is available from Rota Engineering, Ltd. of Manchester, UK. The Rota device is one example of a Hall effect linear transducer. The Rota device has a microprocessor that reads the individual Hall sensor outputs and correlates the Hall effect sensor voltage with a piston position. The Rota device then outputs a voltage, current, or other signal that can be linearly related to the location of the internally mounted magnet (e.g., piston 3 location). In the example of the Hall-effect sensor, a voltage is generated by each Hall sensor that is proportional to the strength of the detected magnetic field. In operation, the magnetic field generated by the internal magnet passes through and out of the cylinder wall between the north and south pole pieces. By positioning the internal magnet in a region close to the cylinder wall, the magnetic flux is of sufficient density to be detected by a magnetic sensor through the cylinder wall. Voltage signals are simultaneously collected by the sensor controller to determine the precise position of the piston. The Rota sensor then outputs a voltage between 0.5 volts and 5.5 volts, where 0.5 generally represents the piston fully retracted position, and 5.5 volts represents the piston full extended position. One example of the Rota sensor is disclosed in U.S. Pat. No. 9,062,694 hereby incorporated by reference. Other types of linear magnetic sensors could be used, where the output can be related to the position of magnets along the cylinder.

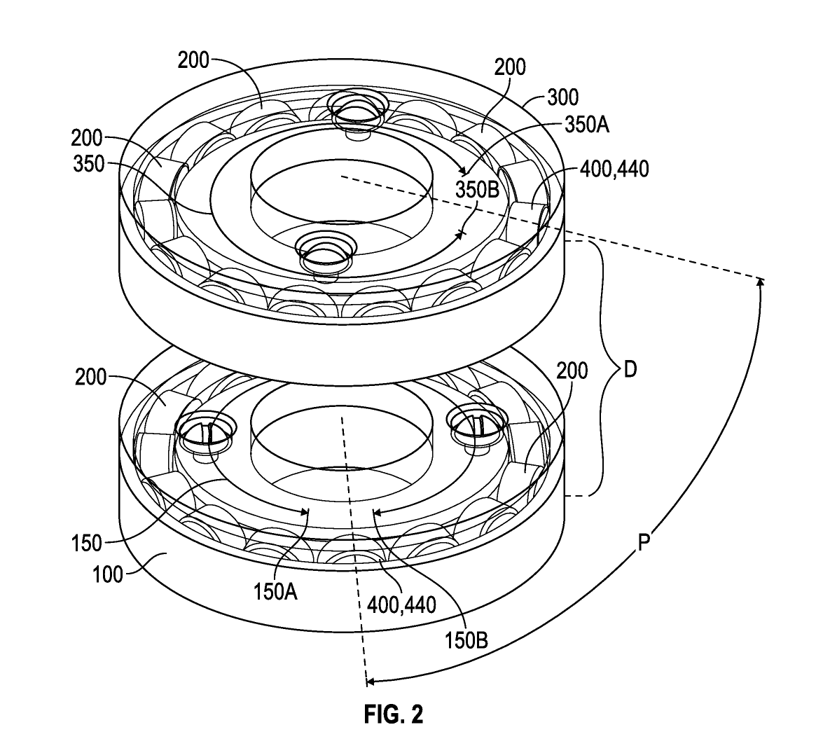

As seen in FIG. 2, one embodiment of the system uses two internal magnetic rings 100, 300 for interaction with the magnetic sensor. Ring 100 is an annulus that has a substantially continuous area of magnetic field generating material, such as permanent magnets 200, positioned in the annular ring 100 along an arc 150 on the outer perimeter of ring 100. The diameter of ring 100 may be close to that of the internal cylinder chamber 2, or that of piston 3. Arc 150 does not encompass the entire circumference of ring 100. Minor gaps may be present between adjacent magnetic field generating material within arc 150, provided that a gap is not so wide that the magnet sensor fails to detect ring 100 in this area (resulting in the sensor being unable to track ring 100 in the magnetic gap or magnetic hole). “Substantially continuous” means that the magnetic sensor, if locked and tracking a particular ring 100 (or 300), will continue to track that particular ring through minor gaps in magnetic coverage in the arc 150. The magnetic field generating material 200, as shown in FIG. 2, may be disk-shaped permanent magnets (for instance neodymium magnets), but electromagnets could also be used as the magnetic field generating material. The magnetic orientation or polarity of magnets 200 within each arc 150 is consistent so that the generated magnetic field—viewed from the position of the externally mounted sensor—is consistent. For use with the Rota device, one preferred orientation has the “N” pole facing the exterior of ring 100 with the S pole facing the interior of ring 100. Other magnet shapes could be used, such as arch-shaped block magnets or U-shaped magnets with the ends of the “U” facing the outer perimeter. Other magnetic orientations can be used that can be sensor dependent.

Arc region 150 of magnetic field generating material does not encompass 360 degrees, but may be less. Each arc region 150 has two terminating points 150A and 150B, creating a gap between sequential arc regions 150, or if a ring 100 contains only a single arc region 150, a gap at the end of that arc region 150. These gaps in arc regions 150 form “blind zones” 400. The magnetic properties of blind zones 400 are substantially different from that generated in arc regions 150. For instance, within blind zone 400 (shown in FIG. 2) is located magnetic material 440 with the polarity reversed from that of the magnetic arc regions 150 and 350—that is, the direction of the magnetic field lines produced in blind zone 400 are substantially reversed from those produced within the magnetic arc region 150. In the example above, blind zone 400 is filled with a magnet having an S pole facing the exterior of ring 100 and an N pole facing the interior of ring 100. Blind zone 400 thus generates substantially different magnetic field lines from those of the magnetic arc regions 150, 350. Consequently, when blind zone 400 is facing magnetic sensor 20 (i.e., blind zone 400 is on the interior cylindrical wall at a location closest to the magnetic sensor 20), the interaction with the magnetic sensor 20 will be substantially different from that produced in the magnetic arc regions 150 and 350. As used herein, “substantially different” magnetic properties of bind zones 400 means that if sensor 20 is tracking a particular ring 100 or 300 through a magnetic arc region 150 or 350 respectively, then when blind zone 400 interacts with sensor 20, the sensor 20 loses “lock” on that tracked ring 100, as later described.

The minimum circumferential extent of blind zone 400 (reversed polarity perimeter area in FIG. 2) is dependent on the field strength of the magnet, the sensitivity of the exterior mounted magnetic sensor 20, and the diameter of ring 100. For use with a three inch diameter ring 100, a minimum perimeter area encompassing 3 to 5 degrees (about 0.08 to 0.13 inches measured on the perimeter) is sufficient for a blind zone reversed polarity area. The blind zone can be wider than this, but the blind zone cannot be so wide to overlap a blind zone in the other remaining ring. Preferably, the ends of each blind zone in the first ring are offset from the blind zones in the second ring by a minimum separation P.

The second magnetic ring 300 is similar to ring 100—an annular ring with a substantially continuous arc 350 of material, where the magnetic field generating material is orientated to produce the same orientation of magnetic field lines as ring 100 (for instance, the magnetic materials can have the same orientations as that in the first ring described above—N pole facing the ring exterior, and S pole facing the ring interior). Ring 300 also contains a “blind zone” 400 at the end of the arc 350. As with blind zone 400 of ring 100, blind zone 400 of ring 300 produces a substantially different magnetic field from that of the magnetic arc region 350 (as shown in FIG. 2, blind zone 400 is a magnet with the S pole facing the exterior of ring 300, the N pole facing the interior of ring 300). The first and second magnetic rings 100, 300 will be coupled to the piston 3 (or to the rod 4, or one to piston 3 and one to rod 4) in a particular orientation—each ring 100, 300 will be coupled so that rings 100, 300 are vertically separated from one another by a separation offset distance “D”, such that blind zones 400 are rotationally misaligned along the perimeter by an angular or perimeter distance separation P. The two rings 100, 300 are fixed in position with respect to one another, but rotate and translate with the piston 3 or rod 4.

Instead of separate rings 100, 300 that are coupled to the piston 3 or rod 4, piston 3 may have annular ring groove(s) positioned on the exterior surface to accommodate an annular arc region of magnetic field generating material and the accompanying blind zone 400. An arc groove in piston 3 is considered a “ring” that is coupled to the piston 3.

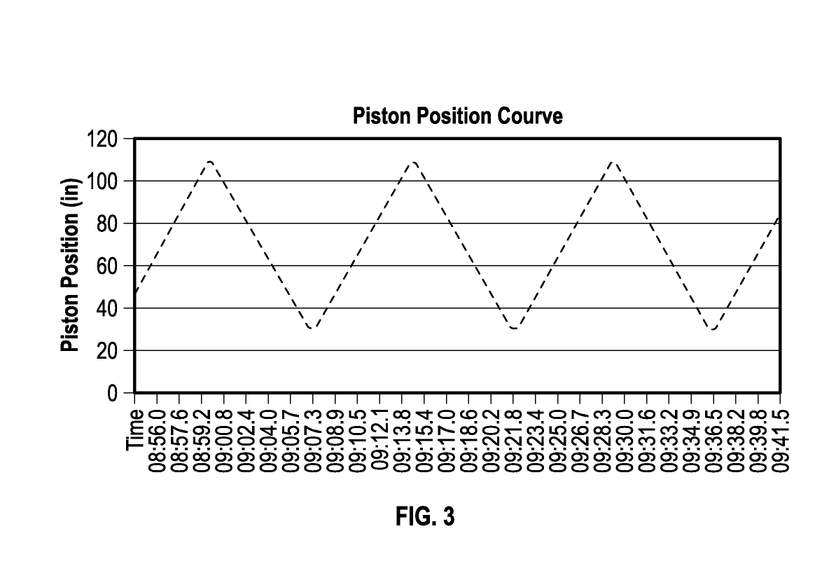

When used with the Rota device or sensor when piston 3 has a 3 inch diameter, piston 3 is moving at about seven strokes per minute, with a stroke length of about 120 inches, one exemplary offset distance D is about 1.25 inches, and an exemplary perimeter blind zone length is about 3-5 degrees (or a perimeter distance of about 0.08-0.0.13 inches). The length of the blind zone will depend on magnet strength, sensitivity of the magnetic sensor, and piston stroke speed. It is preferred to separate the blind zones 400 between the rings 100, 300 by a separation P, as shown in FIG. 3. In this particular embodiment, about 25 degrees of separation, or about 0.65 inches along the ring perimeter, has been found acceptable. The amount of separation P will depend on sensor sensitivity, magnet strength, piston speed, and rotational speed. Each ring 100, 300 may have multiple magnetic arc regions 150, 350, each terminating in a blind zone 400, where substantially different magnetic fields are produced. However, the blind zones 400 on the first ring 100 are misaligned with the blind zones 400 or regions of the second ring 300.

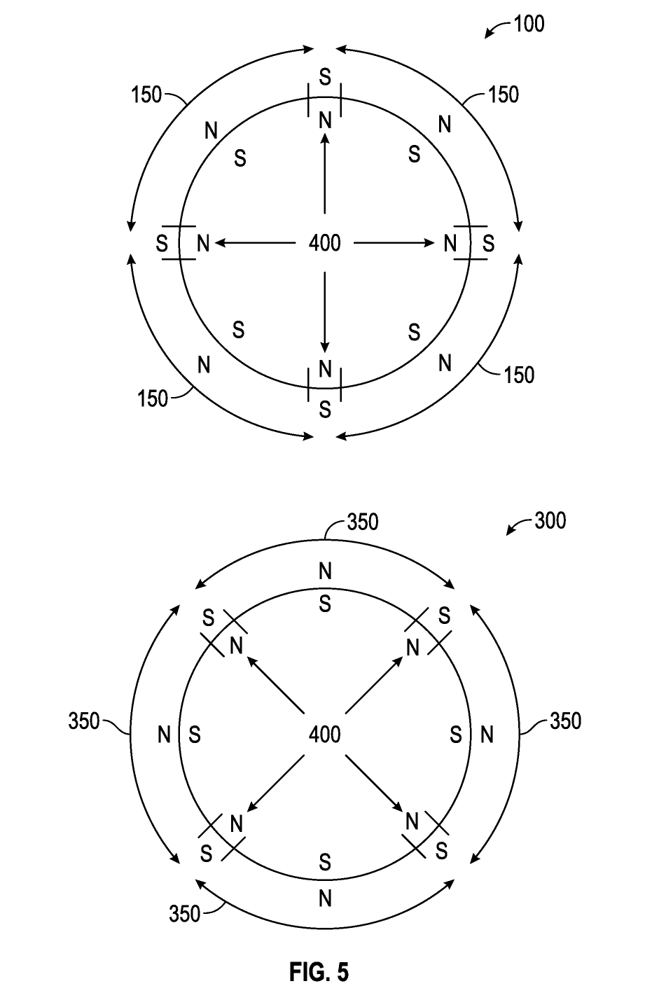

For instance, depicted in FIG. 5 are two rings 100, 300, each with four blind zones 400 (four reversed polarity regions), where each blind zone 400 on the same ring is offset from the next by 90 degrees. The first ring 100 is misaligned with the second ring 300 by 45 degrees. Each ring 100, 300 must have at least one blind zone 400, but the number of blind zones 400 on each ring 100, 300 do not have to match.

In one embodiment, as rod 4 moves up and down, when it reaches the top of its extent, a small rotation occurs. Due to misalignment of blind zones 400 between ring 100 and 300, a ring magnetic arc region 150 or 350, will always be facing the magnetic sensor 20. It has been found experimentally that the Rota device or sensor will track only one of the two magnetic rings 100, 300 at a time. Apparently, the Rota device or sensor bar tracks or locks onto one of the rings 100, 300, and will track that ring until “lock” is lost, as next described.

On startup, the Rota Hall effect device begins tracking the “closest” ring 100, 300, that is, the ring closest to the “0” position (for instance, if the two rings 100, 300 are separated by 1.25 inches, one ring's position would be X, and the other ring's position would be x+1.25 inches; the Rota device would initially track the ring at position X). For ease of description, assume the Rota device is tracking first ring 100. As the rod/piston reciprocate, the magnetic sensor device 20 calculates a position based on the location of the magnets in ring 100. However, rotation of the piston 3 also occurs. At some point, ring 100 will rotate sufficiently so that the blind zone 400, such as a reversed polarity region, is facing or interacting with the sensor bar 20.

While not wishing to be bound by any particular theory, since the sensor bar 20 is tracking the location of the expected Hall effect voltage near arc region 150 of ring 100, the Hall effect sensor, when interacting with a reversed polarity blind zone 400, will “lose” track of ring 100, as the generated Hall effect voltage produced by interaction with the blind zone 400 is substantially different from that produced in the arc area 150. That is, the controller of the Hall sensor bar 20 will not identify the location of the rod/piston with the location of ring 100, as that location is not producing a Hall effect voltage that the sensor identifies with the “location” of an interacting magnet. The sensor bar 20 will now lock onto ring 300 as the location of the piston, as the arc region 350 of ring 300 faces the sensor 20 (due to the intentional misalignment of the blind regions 400 in the two rings 100, 300, and produces the desired Hall effect voltage. Consequently, the magnetic sensor “loses” track of ring 100, but detects ring 300, and the sensor 20 now begins to track ring 300. The sensor bar 20 thus has lost “lock” with ring 100 magnets and now is locked onto the magnets in ring 300. The sensor bar 20 will remain locked on and continue to track the location of ring 300, even after additional rotation of the piston 3 places ring 100 in the normal polarity orientation. In essence, the sensor bar 20 ignores ring 100 readings, until such time as ring 300 rotates sufficiently so that a blind zone 400 in the ring 300 is interacting with the sensor bar 20. At this point, the sensor bar 20 now loses “lock” with ring 300, and will lock onto and track ring 100. In this fashion, the magnetic sensor 20 ping-pongs back and forth between the two magnetic rings 100, 300, switching between rings only when detection “lock” is lost on a tracked ring (i.e. a blind zone 400 is encountered). The blind zone regions are thus used to “switch” the sensor 20 from tracking one ring to the other ring.

A similar result should be obtained if, instead of a reversed polarity region, a sufficiently wide non-magnetic perimeter region is included at the end of each arc region (e.g. a magnetic hole). If the non-magnetic area is long enough, the sensor 20 should lose track of the ring as the magnetic field strength drops in this region, and the Hall effect voltage will drop. A non-magnetic blind zone region along the perimeter likely will need to be longer in length than would a reversed polarity region. While complete reverse polarity (180 degree shift) produces the most significant changes in the field lines through the magnetic sensor 20, other magnet orientations in the blind zones (such as at 90 degrees to the arc magnet orientations) may produce enough field variations at the magnetic sensor 20 to cause the sensor 20 to lose track in the blind zone. The amount of field variation (or the orientation of the magnets) that will interrupt sensor tracking (e.g. loss of lock) will depend on the sensitivity of the particular sensor.

If the magnetic sensor controller is not configured as the Rota device, the sensor controller would need to be reconfigured to operate as the Rota device—that is, to track a single ring until a blind zone is reached, then to transition to the other ring for tracking purposes.

When the sensor 20 “shifts” from reading one ring to the other ring, the position of the piston 3 determined by the sensor bar 20 will suddenly shift by +/−D, the ring separation distance. The reported position of the piston 3 should account for this shift. For instance, if the desired “reported” location of piston 3 is deemed to be ring 100's location (the ring closest to the “0” position), then when the sensor bar 20 is tracking position based on ring 300 readings, the reported position will need to be adjusted to “measured position of ring 300−D”. Similarly, if the desired position is to be that of ring 300, then when reading ring 100, the reported position should be adjusted to “measured position of ring 100+D.” Consequently, the sensor controller 20, or other controller, in order to properly reflect piston 3 location, needs to track which ring 100 or 300 is currently being used, and adjust the measured position accordingly.

In order to detect ring transition, the sensor controller 20, or a separate controller, preferably calculates the derivative of the sensor output reading. As used herein, derivative means a discrete time rate of change of a quantity, and does not represent an “instantaneous” derivative. For instance, if the sensor output is a voltage (in my), or a position (in inches), or a current (ma), the controller calculates the “derivative” (output 2-output 1)/(time 2-time 1) of the measured quantity. This derivative can be done on raw output data, or on conditioned output data (such as after smoothing, filtering, etc). When the sensor transitions between rings 100, 300, the measured output value will show a sudden shift (represented by at the ring separation distance D), and the derivative will reflect this shift and can be used as an indicator that the sensor 20 has shifted between rings 100, 300. Alternatively, the difference in raw or conditioned sensor output values, or sensor detected piston position, can also be used to determine when a shift between rings 100, 300 has occurred.

The desired “shift” reflected in the derivative or other quantity will preferably sufficiently exceed the expected derivative (plus system noise) of sequential non-shifted readings (assuming sequential readings are use). For instance, in a 3 inch diameter piston system, with a stroke of about 120 inches, moving at a speed of 7 strokes per minute (about 14 inches/sec) (where 0 inches corresponds to a voltage of 0.5 volts, and 120 inches corresponds to an output voltage of 5.5 volts), with readings taken every 50 msec, the expected change in position for adjacent readings is about 0.7 inches, or about 35 mv (note 35 my/50 msec represents a derivative of 0.7). A shift of 1.25 inches (e.g. the ring separation D distance) represents a voltage shift of about 64 mv (a derivative value of 65/50 or 1.3). This 64 mv (or 1.3 derivative value) differential reading is significantly above the expected level of differential value of 35 mv (or 0.7 derivative value) for sequential readings, and a suitable threshold value can be selected to designate that a shift from ring 100 to ring 300 has occurred. For instance, a threshold of 50 mv, (or a derivative of 1.0 value) could be selected as a threshold.

As an example, a change in sequential readings (in my) in absolute value that is greater than 50 mv (or a derivative that is greater in absolute value than 1.0) could be a threshold to determine a shift from ring to ring, The sign of the shift or derivative can be used to determine if the shift is from ring 100 to 300, or ring 300 to 100. As can be seen, the thresholds are related to the offset distance D separating the rings, while the desired offset distances D are related to the piston speed, noise levels, and output range of the sensor 20.

The indication that the sensor 20 has shifted between rings 100, 300 is also a confirmation that piston 3 has rotated. If each ring contains a single blind region 400, then a complete cycle (e.g. read ring 100 arc, read ring 300 arc, and return to ring 100) indicates that the rod/piston 3, 4 has rotated 360 degrees. With multiple arc regions, each followed by a blind zones 400, the sensor 20 can tract rotation of the rod 4 in finer increments (for instance, if each ring 100, 300 has four reverse polarity regions, each misaligned by 45 degrees, then each shift between rings 100, 300 represents a rotation of 45 degrees).

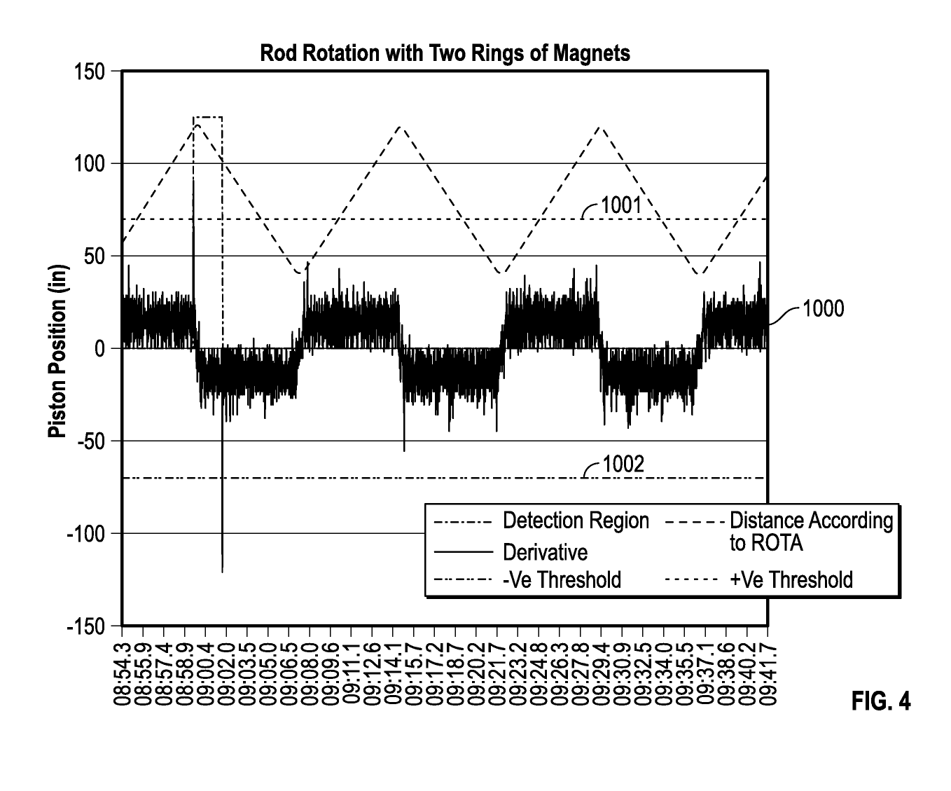

As an example, FIG. 3 shows the plotted positional output from the Rota sensor (in inches). The oil jack was set to about 7 strokes/min, but the piston 3 did not move along the entire 120 in range. Shown in FIG. 4 is the graph of the derivative 1000 of the sensor output (in mv), overlaid onto the graph of the calculated piston position (in inches) along the sensor bar 20. A positive derivative indicates an upward movement of the piston 3, while a negative derivative indicates a downward movement. Note that the derivative shows a positive spike at about time 9.00.4 and a negative spike at about time 9.02.0. The positive spike indicates a transition from the lower ring 100 to the upper ring 300, and the negative spike depicts the negative jump in the derivative on the transition between the upper ring 300 to the lower ring 100. These spikes can be used to confirm that the piston 3 is rotating. These same spikes will be used by the controller to compensate the calculated and reported piston position by the ring separation distance D (1.25″ in this case). The position displayed in FIG. 4 is the compensated position. Potential thresholds 1001 and 1002 are also shown on the graph. The derivative signal can be digitally manipulated to amplify the spikes attributed to ring transitions and to minimize any other artifact that could affect detection if desired. In a similar manner, thresholds can be adjusted as desired.

As can be seen, the two ring system allows computation of linear position of the piston 3 as well as computation of the rotational position of the piston 3 (in less granular increments). Instead of taking the derivative, (delta position)/(delta time increment), since the sampling interval is constant, it is also possible to simply compare (delta position) of the sensor output or calculated sensor position for an indication that the sensor has switched magnetic rings. The invention is not necessarily limited to the linear actuator structure shown in the Figures. The system and method allows for rod movement in two dimensions, such as piston movement along its own central axis, and concentric rod rotation. The system and method can be applied to any system or device that requires non-interrupted detection of the magnetic field, such as the case of piston movement along its axis, and that requires rod rotation detection and count estimation.

The described and illustrated embodiments are to be considered as illustrative and not restrictive in character, it being understood that only the preferred embodiments have been shown and described and that all changes and modifications that come within the scope of the inventions as defined in the claims are desired to be protected. It should be understood that while the use of words such as “preferable”, “preferably”, “preferred” or “more preferred” in the description suggest that a feature so described may be desirable, it may nevertheless not be necessary and embodiments lacking such a feature may be contemplated as within the scope of the invention as defined in the appended claims.

What is claimed is:

1. A linear actuator comprising:
a cylinder and a piston disposed inside the cylinder for reciprocal movement along a cylinder axis and rotational movement about the axis, the cylinder having a wall with an internal surface and an external surface, the piston having axially spaced first and second end surfaces;
a magnetic sensor axially disposed adjacent to the external surface of cylinder;
a rod connected to the piston;
a first ring operationally coupled to the piston or rod at a first location, the first ring comprising a magnetic field generating material disposed in a substantially continuous first ring arc region, the first ring arc region located on an outer perimeter of the first ring, the magnetic field generating material in the first ring arc region has a first magnetic polarity orientation, the first ring arc region terminates in a first ring blind zone in the first ring;
a second ring operationally coupled to the piston or rod at a second location, the first location axially spaced apart from the second location by a distance D, a magnetic field generating material disposed in a substantially continuous second ring arc region located on an outer perimeter of the second ring, the magnetic field generating material in the second ring arc region has the first magnetic polarity orientation, the second ring arc region terminates in a second ring blind zone, the first ring blind zone being axially aligned with the second ring arc region, the second ring blind zone being axially aligned with the first ring arc region;
wherein a magnetic field produced by the first ring blind zone is substantially different from that produced by the first ring arc and a magnetic field produced by the second ring blind zone is substantially different from that produced by the second ring arc region.

2. The linear actuator of claim 1 wherein the first and second blind zones produce magnetic field lines reversed from the magnetic field lines in the first and second arc regions respectively.

3. The linear actuator of claim 2 wherein the first and second rings each have a single blind zone, the blind zone of the first ring is separated from the blind zone of the second ring by 25-180 degrees.

4. The linear actuator of claim 1 wherein the first and second rings each have two or more blind zones.

5. The linear actuator of claim 1 wherein the magnetic sensor comprises a Hall effect bar sensor.

6. The linear actuator of claim 5 wherein the magnetic sensor is configured to output a value that is related to the location of the piston in the cylinder.

7. The linear actuator of claim 6 wherein the output value is further related to either the position of the first ring or the position of the second ring.

8. The linear actuator of claim 7 further comprising a controller, wherein the controller is in communication with the magnetic sensor, the controller configured to determine which of the first or second rings position is related to the magnetic sensor output.

9. The linear actuator of claim 8 wherein the controller is further configured to output a piston position in the cylinder, wherein the controller outputted piston position is equal to (a) the magnetic sensor determined piston position or (b) the magnetic sensor determined piston position, plus or minus D.

10. A method to determine linear position and rotation of a reciprocating and rotating piston in an hydraulic cylinder using an output of a magnetic sensor, wherein an absolute value of a change in piston location between sequential measurements of the piston by the magnetic sensor is a value A, the method comprising the steps of:
a) receiving a first output of the magnetic sensor, wherein the first output is correlatable to a first linear position of the piston in the hydraulic cylinder;
b) receiving a sequential second output of the magnet sensor, wherein the second output is correlatable to a second linear position of the piston in the hydraulic cylinder;
c) determining that the cylinder is rotating when the absolute value of difference of the second linear position and the first linear position exceeds A by a predetermined value P.

11. A method to determine linear and approximate rotational position of a reciprocating and rotating piston in an hydraulic cylinder, wherein a stroke speed of the piston is less than Y in absolute value, the method comprising the steps of:
a) receiving a plurality of outputs of the magnetic sensor, and determining a linear position of the piston for each of the outputs;
b) determining a derivative of a quantity related to the output of the magnetic sensors;
c) determining that the piston has rotated when the absolute value of the derivative exceeds a predetermined value.

12. The method of claim 11 wherein the derivative is taken of the outputs of the magnet sensor.

13. The method of claim 11 wherein the derivative is taken from the linear position of the piston calculated from the outputs of the magnetic sensor.

14. The method of claim 13 wherein the predetermined value in absolute value is greater than Y.

15. A method of determining piston location in a system comprising a linear actuator comprising a piston and a cylinder, the piston disposed inside the cylinder for reciprocal movement along a cylinder axis and rotational movement about the axis, the cylinder having a wall with an internal surface and an external surface; a magnetic sensor axially disposed along the external surface of the cylinder; a rod connected to the piston, a first ring operationally coupled to the piston or the rod at a first location, the first ring comprising a magnetic field generating material disposed in a substantially continuous first ring arc region, wherein the first ring arc region is located on an outer perimeter of the first ring, the magnetic field generating material in the first ring arc region has a first magnetic polarity orientation, the first ring arc region terminates in a first ring blind zone; a second ring operationally coupled to the piston or rod at a second location, the first location axially spaced apart from the second location by a distance D, the magnetic field generating material disposed in a substantially continuous second ring arc region located on an outer perimeter of the second ring, the magnetic field generating material in the second ring arc region has the first magnetic polarity orientation, the second ring arc region of magnetic field generating material terminates in second ring blind zone; the first ring blind zone being axially aligned with the second ring arc region, and the second ring blind zone being axially aligned with the first ring arc region; the first ring and the second ring move with the piston but are fixed with respect to one another; the method comprising the steps of:
a) determining a position of the piston by interaction of the first magnetic arc region with the magnetic sensor;
b) on interaction of the first ring blind zone with the magnetic sensor, determining the position of the piston through interaction of the second ring arc region with the magnetic sensor;
c) on interaction of the second ring blind zone with the magnetic sensor, determining the position of the piston based upon interaction of the first ring arc region with the magnetic sensor;
d) repeating steps b) and c).

16. The method of claim 15 further comprising the steps of determining that the piston has rotated 360 degrees after performing each occurrence of steps b) and c).

17. The method of claim 15 wherein the magnetic field generating material in the first and second arc regions are permanent magnets.

18. The method of claim 17 wherein the first bind zone further comprise a first blind zone permanent magnet orientated opposite that of the permanent magnets of the first arc region and the second blind zone further comprises a second blind zone permanent magnet orientated opposite that of the permanent magnets of the second arc region.
